(19) United States
(12) Patent Application Publication
(10) Pub. No.: US 2019/0310964 A1
(43) Pub. Date: Oct. 10, 2019

(54) SPECULATIVE READ MECHANISM FOR DISTRIBUTED STORAGE SYSTEM

(71) Applicant: INTEL CORPORATION, Santa Clara, CA (US)

(72) Inventors: Zhiyuan ZHANG, Beijing (CN); Xiangbin WU, Beijing (CN); Qianying ZHU, Beijing (CN); Xinxin ZHANG, Beijing (CN); Haitao JI, Beijing (CN); Yingzho SHE, Beijing (CN)

(21) Appl. No.: 16/346,842

(22) PCT Filed: Dec. 28, 2016
(86) PCT No.: PCT/CN2016/112611

§ 371 Date: May 1, 2019

(51) Int. Cl. G06F 15/173; G06F 13/20; G06F 13/40

(52) U.S. Cl. CPC G06F 15/17331; G06F 13/4027; G06F 13/20

(57) ABSTRACT

Provided is an apparatus directing to a speculative read mechanism for a distributed storage system. The apparatus includes a remote direct memory access (RDMA) network interface card (RNIC) (100) for a server (250), wherein the RNIC (100) includes an onboard memory (105), a trigger control (120) and a port for connection of the RNIC (100) to a client (200). The onboard memory (105) is operable to provide a buffer (110) for storage of data from a distributed storage system for a read request from the client (200). The trigger control (120) includes a programmable trigger condition. The RNIC (100) is operable to support a speculative read of data in response to a read request snoop of a write of data to the onboard memory (105), and upon detecting the trigger condition, to provide the data in the buffer to the client (200).

### TECHNICAL FIELD

Embodiments described herein generally relate to the field of electronic devices and, more particularly, a speculative read mechanism for a distributed storage system.

### BACKGROUND

Distributed storage systems in general include many storage devices that are networked together to provide storage for large quantities of data. RDMA (Remote Direct Memory Access) refers to a direct memory access between systems in a network, allowing computers in a network to exchange data in main memory without involving the processor, cache, or operating system of either computer. In particular, NVMe (Non-Volatile Memory Express) is a logical device interface specification regarding access to non-volatile storage media attached via a PCIe (PCI Express) bus, wherein NVMe over Fabrics supports multiple different storage networking fabrics. See “NVM Express”, Revision 1.2.1 (Jun. 5, 2016) and “NVM Express Over Fabrics”, Revision 1.0 (Jun. 5, 2016).

In current distributed storage systems, a read response for a client is sent by the storage server after the disk read request completion is seen by the server CPU (central processing unit). Once the server NVMe driver detects the completion of a read request, the server CPU directs the NIC (Network Interface Card) to send read data back to the client.

However, while the data for a read request is present in a buffer before the completion of the read request is posted in the completion queue, conventionally the NVMe over Fabric is not able to access this data, and the completion of a read request is delayed until the full completion of the read request process.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of a network interface card to support speculative read data from a server in a distributed storage system to a client according to an embodiment;

FIG. 2A is an illustration of a client apparatus for receiving speculative read data from a server in a distributed storage system according to an embodiment;

FIG. 2B is an illustration of a server apparatus with RDMA network interface card to support speculative read data to a client according to an embodiment;

FIG. 3 is an illustration of operations in a speculative read operation between a client system and a server system;

FIG. 4 is a flowchart to illustrate a process for speculative read operation in a distributed storage system; and

FIG. 5 is an illustration of a system to provide support for a speculative read in a distributed data storage according to an embodiment.

### DETAILED DESCRIPTION

Embodiments described herein are generally directed to a speculative read mechanism for a distributed storage system.

For the purposes of this description:

“Distributed storage system” refers to a system in which multiple storage devices are networked together to provide storage for large quantities of data. As used here, a distributed storage system includes a block based storage system or a distributed object storage system.

In some embodiments, an apparatus, system, or method provides for an RDMA (Remote Direct Memory Access) based distributed storage system to speculatively return completion data to a client from the RNIC (RDMA Network Interface Card) prior to completion of the read request, such as, for example, prior to the server CPU receiving the read request completion from an NVMe (Non-Volatile Memory Express) completion queue. In some embodiments, the implementation of a speculative read may be implemented to significantly reduce latency and improve performance of an RDMA based storage system by enabling the return of data to a client before the server CPU obtains the read request completion from an NVMe completion queue.

RDMA communication is based on a set of three queues in system memory. The Send Queue and Receive Queue are responsible for scheduling work, the Send Queue and Receive Queue being created in pairs, referred to as a Queue Pair (QP). The third queue is the Completion Queue (CQ), used to provide notification when the instructions placed on the work queues have been completed. Upon the transaction being completed, a Completion Queue Element (CQE) is created and placed on the Completion Queue.

In some embodiments, an RNIC includes on board memory that server software may utilize as, for example, an NVMe read buffer to which the NVMe unit can directly write data. The RNIC is capable of snooping the DMA write to its onboard memory. Each time the snoop operation meets a trigger condition, such as a condition set by server software or by another element, the RNIC can speculatively send the read data to the client. In some embodiments, the trigger condition may occur after part or all of the read data is written to the RNIC buffer, which occurs before the NVMe command is completed and the respective Completion Queue Element is seen by the server CPU on the Completion Queue.

In some embodiments, an RNIC to support speculative read includes, but is not limited to, the following:

(a) Includes onboard memory that is mapped to RNIC BAR (base address registers), wherein the onboard memory can be written by the server CPU and by the NVMe storage device, the storage device being a non-volatile storage media including, for example, flash memory, a Solid State Drive (SSD), and a USB (Universal Serial Bus) drive.

(b) Operable to snoop writes to the onboard memory, and to trigger RDMA write to clients by in response to a trigger condition that is set by a server, including setting of the trigger condition by server software.

(c) Includes a mechanism to enable setting (such as by server software) of RDMA trigger condition and speculative read response RDMA QPs and address.

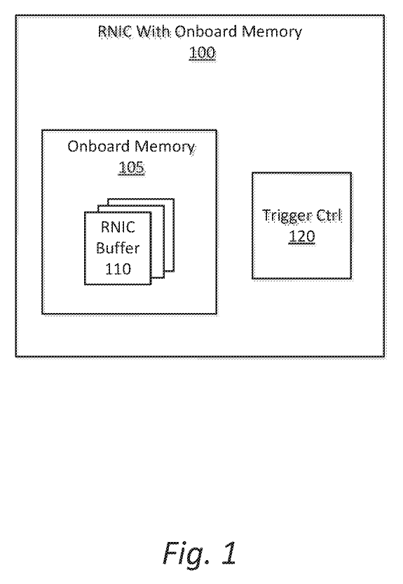

FIG. 1 is an illustration of a network interface card to support speculative read data from a server in a distributed storage system to a client according to an embodiment. In this illustration, an RNIC (RDMA network interface card) 100 includes onboard memory 105 that may be utilized as an RNIC data buffer 110. In some embodiments, the onboard memory may be utilized as, for example, an NVMe read buffer to which an NVMe storage may directly write data (i.e., in a DMA operation) to store data resulting from a read request from a client.

In some embodiments, the RNIC 100 is operable to snoop the DMA write to the onboard memory 105. Further, the RNIC 100 includes a trigger control 120, which may include a trigger condition. In some embodiments, the trigger condition is set by software of the server, or is otherwise established for the speculative read operation, such as by client software. In some embodiments, in response to the snoop operation of the RNIC on the DMA write meeting the trigger condition for the trigger control 120, the RNIC is to speculatively send the read data from the RNIC buffer to the client. In this manner, the data is provided before a completion of the NVMe read command can be written to the queue and be recognized by the server CPU.

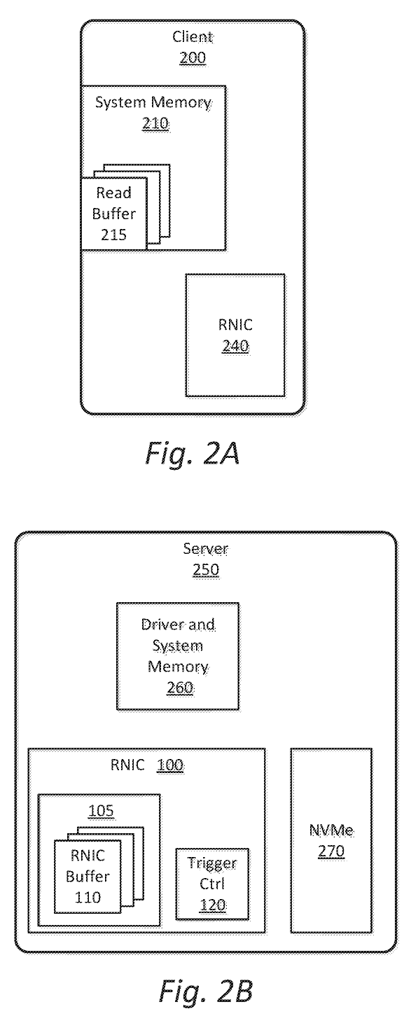

FIG. 2A is an illustration of a client apparatus for receiving speculative read data from a server in a distributed storage system according to an embodiment. In some embodiments, a client apparatus 200 is a client in a distributed storage system such as, for example, an NVMe storage system. In some embodiments, the client 200 includes a system memory 210 that may include a read buffer 215 for receipt of read data as a result of a direct RDMA read request from an RDMA network interface card (RNIC) 240 of the client 200.

The client RNIC 240 is operable to provide an RDMA read request to a distributed storage system server, such as an NVMe server, receive resulting read data from the server, and write the received read data to the read buffer 240. In some embodiments, the client RNIC 240 is operable to receive speculative read data from the server, and to write the speculative data to the read buffer 215.

FIG. 2B is an illustration of a server apparatus with RDMA network interface card to support speculative read data to a client according to an embodiment. In some embodiments, a server 250 includes distributed data storage, and more specifically may include an NVMe storage 270. In some embodiments, the server 250 further includes a driver and system memory 260, and an RNIC 100, which may include the RNIC 100 illustrated in FIG. 1, wherein the RNIC includes onboard memory 105, which may include an RNIC buffer 110, and a trigger control 120.

In some embodiments, the server 250 is operable to provide speculative read data support for a client in response to an RDMA read request. In some embodiments, the RNIC buffer 110 is to receive read data directly from the NVMe storage, and is operable to snoop the storage data. In some embodiments, the RNIC is operable to transmit data from the RNIC buffer 110 to the client upon meeting a trigger condition according to the trigger control 120.

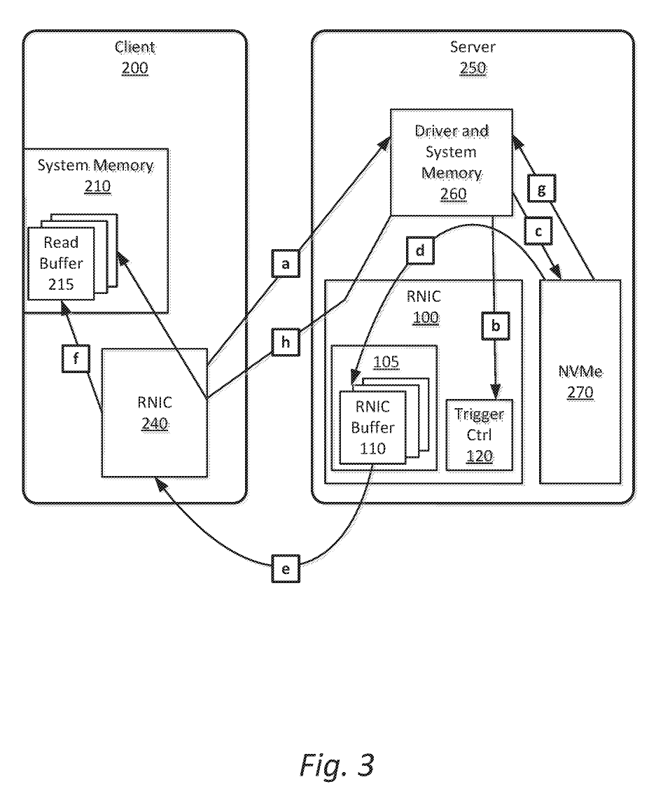

FIG. 3 is an illustration of operations in a speculative read operation between a client system and a server system. In some embodiments, a client 200, such as illustrated in FIG. 2A, and server 250, such as illustrated in FIG. 2B, in a distributed storage system may perform a speculative read operation, wherein the operational flow of the speculative read in the storage system includes the following:

(a) The client 200 posts a Read (containing LBA (Logical Block Address). Length) request to server, the request further including identification of the client buffer that is to receive read data.

(b) After the server receiving the Read request, the server 250 allocates RNIC onboard memory 105 and sets up the trigger condition on RNIC trigger control 120 to enable the speculative RDMA write to the client read buffer.

(c) Server driver directs the request (LBA, Length) to the NVMe 270 and sets an RNIC data buffer 110 in the allocated memory 105 on the server RNIC 100.

(d) NVMe 270 performs the requested read, and provides DMA write of the obtained read data to the RNIC data buffer 110.

(e) The RNIC 100 snoops the DMA write to the RNIC data buffer 110, and triggers an RDMA write of the stored data from the RNIC buffer 110 of the server 250 to the RNIC 240 of the client based on the established trigger condition.

(f) The client RNIC 240 writes the data from the RDMA write to client's read buffer 215 in the client system memory 210.

(g) The NVMe 270 completes the read process and writes Completion Queue Entry in in the Completion Queue in system memory 260.

(h) Server driver 260 writes the completion status to the client 200 via the RNIC 240 of the client 200. In an embodiment, the speculative read data has been previously received, and the data is available in the read buffer 215 of the system memory 210.

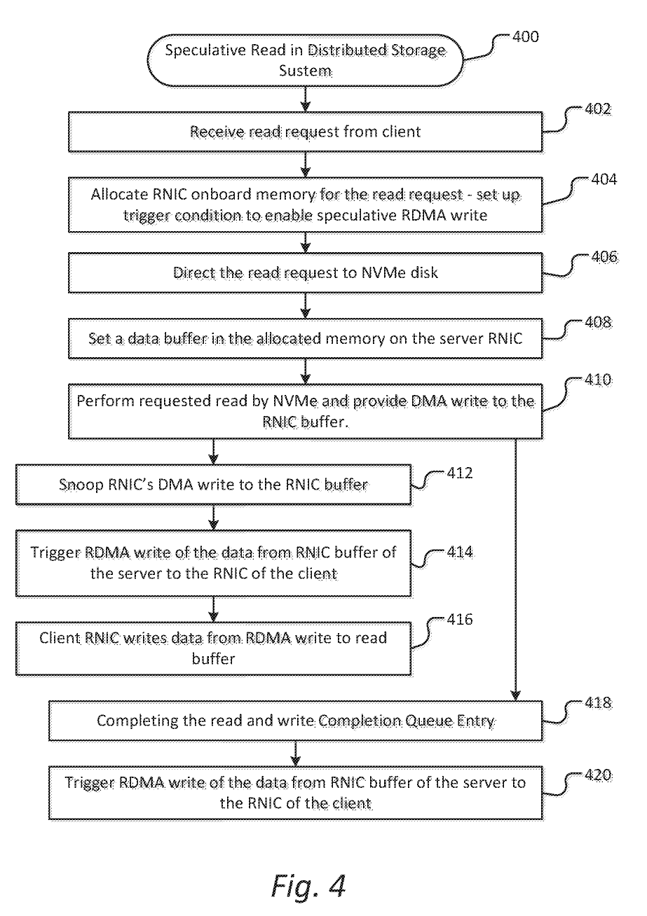

FIG. 4 is a flowchart to illustrate a process for speculative read operation in a distributed storage system. In some embodiments, a process 400 may include the following:
402: Receive at a server in distributed storage system a read request from a client. The request may include identification of a client buffer to directly receive requested read data.
404: Upon receiving the read request, allocate RNIC onboard memory for the read request, and setting trigger condition to enable a speculative RDMA write to client read buffer upon receipt of data at the RNIC.
406: Direct the read request to the distributed storage unit, such as NVMe storage device.
408: Set a data buffer in the allocated memory on the server RNIC.
410: Perform the requested read by the NVMe, and provide DMA write of the obtained read data to the RNIC buffer.
412: Snoop, by the RNIC, the DMA write to the RNIC buffer.
414: Upon meeting the set trigger condition for the speculative read, trigger an RDMA write of the data from the RNIC buffer 110 of the server to the RNIC 240 of the client based on the established trigger condition.
416: The client RNIC then writes the data that is received from the server RNIC to the client's read buffer in the client system memory.
418: Overlapping in time or subsequent to the processes including snooping of the DMA write 412, writing of the speculative read 414, and writing of the data to client's read buffer 416, completing the read and write Completion Queue Entry in in the Completion Queue in system memory.
420: In response to the Completion Queue Entry, writing the completion status to the client via the RNIC of the client. However, the speculative read data has already been previously received, and the data is available in the read buffer of the system memory of the client.

In some embodiments, utilizing this mechanism, the data transfer on network occurs prior to the NVMe read command being on PCIe bus, with the read latency being greatly reduced. In some embodiments, the mechanism may be implemented both in block based storage system usage scenario, such as NVMe over Fabric, and in distributed object storage system such as Ceph and OpenStack Object Storage (Swift).

For the applications that have relaxed requirement on data consistency such as video streaming, it is also possible to directly send speculative read data to client app before NVMe response is sent to the CPU.

In an embodiment, read latency and performance may be particularly benefited when the request size is large because the RNIC is not required to wait the full length of time for the long data read to be finished by an NVMe storage device. The client data may be sent to client before the read is fully completed and an interrupt is required on the server side.

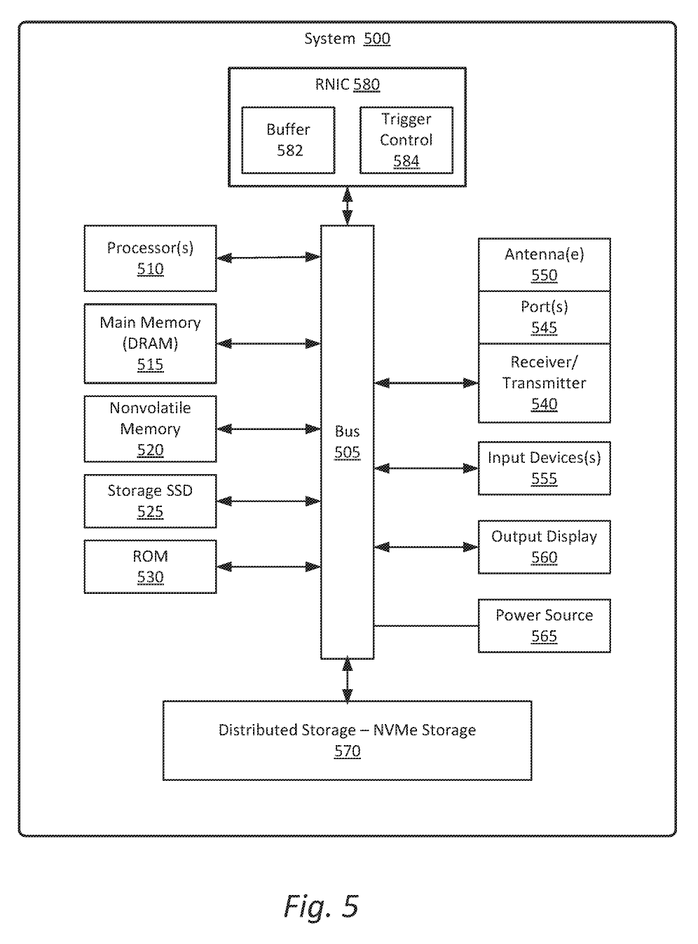

FIG. 5 is an illustration of a system to provide support for a speculative read in a distributed data storage according to an embodiment. In this illustration, certain standard and well-known components that are not germane to the present description are not shown. Elements shown as separate elements may be combined, including, for example, an SoC (System on Chip) or SoP (System on Package) combining multiple elements on a single chip or package.

In some embodiments, a system 500 includes a distributed storage server, including, for example, server 250 illustrated in FIGS. 2B and 3. In some embodiments, the system 500 includes a distributed storage such as an NVMe storage 570. The system 500 further includes an RNIC 580, the RNIC including onboard memory, such as for a buffer 582, and including a trigger control 584. In some embodiments, the system 500 is operable to support speculative provision of read data from the distributed storage 570 via the RNIC 580, the RNIC 580 being operable to snoop direct data writes to the buffer 582 and to provide the stored data to a client system in response to a trigger condition.

The system 500 may further include a processing means such as one or more processors 510 coupled to one or more buses or interconnects, shown in general as bus 505. The processors 510 may comprise one or more physical processors and one or more logical processors. In some embodiments, the processors 510 may include one or more general-purpose processors or special-purpose processors. The bus 505 is a communication means for transmission of data. The bus 505 is illustrated as a single bus for simplicity, but may represent multiple different interconnects or buses and the component connections to such interconnects or buses may vary. The bus 505 shown in FIG. 5 is an abstraction that represents any one or more separate physical buses, point-to-point connections, or both connected by appropriate bridges, adapters, or controllers.

In some embodiments, the system 500 further comprises a random access memory (RAM) or other dynamic storage device or element as a main memory 515 for storing information and instructions to be executed by the processors 510. Main memory 515 may include, but is not limited to, dynamic random access memory (DRAM).

The system 500 also may comprise a non-volatile memory 520; a storage device such as a solid state drive (SSD) 525; and a read only memory (ROM) 530 or other static storage device for storing static information and instructions for the processors 510.

In some embodiments, the system 500 includes one or more transmitters or receivers 540 coupled to the bus 505. In some embodiments, the system 500 may include one or more antennae 550, such as dipole or monopole antennae, for the transmission and reception of data via wireless communication using a wireless transmitter, receiver, or both, and one or more ports 545 for the transmission and reception of data via wired communications. Wireless communication includes, but is not limited to, Wi-Fi, Bluetooth™, near field communication, and other wireless communication standards. In some embodiments, a wired or wireless connection port is to link the RNIC 580 to a client system.

In some embodiments, system 500 includes one or more input devices 555 for the input of data, including hard and soft buttons, a joy stick, a mouse or other pointing device, a keyboard, voice command system, or gesture recognition system. In some embodiments, system 500 includes an output display 560, where the output display 560 may include a liquid crystal display (LCD) or any other display technology, for displaying information or content to a user. In some environments, the output display 560 may include a touch-screen that is also utilized as at least a part of an input device 555. Output display 560 may further include audio output, including one or more speakers, audio output jacks, or other audio, and other output to the user.

The system 500 may also comprise a battery or other power source 565, which may include a solar cell, a fuel cell, a charged capacitor, near field inductive coupling, or other system or device for providing or generating power in the system 500. The power provided by the power source 565 may be distributed as required to elements of the system 500.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

In some embodiments, an apparatus includes a remote direct memory access (RDMA) network interface card (RNIC) for a server, wherein the RNIC includes an onboard memory, the onboard memory being operable to provide a buffer for storage of data from a distributed storage system for a read request from a client, a trigger control, the trigger control including a programmable trigger condition, and a port for connection of the RNIC to the client. In some embodiments, the RNIC is operable to support a speculative read of data in response to a read request snoop a write of data to the onboard memory and, upon detecting the trigger condition, to provide the data in the buffer to the client.

In some embodiments, the trigger condition is programmable by software of the server.

In some embodiments, the RNIC is to provide the data in the buffer to the client prior to completion of the read request by the server.

In some embodiments, the distributed storage system is an NVMe (Non-Volatile Memory Express) system, and wherein the data is provided to the client prior to a central processing unit (CPU) of the server obtaining a read request completion from an NVMe completion queue.

In some embodiments, providing the data in the buffer to the client includes transferring the data from the RNIC to an RNIC for the client.

In some embodiments, a server system includes a central processing unit (CPU); a distributed storage unit; a remote direct memory access (RDMA) network interface card (RNIC) including an onboard memory, the onboard memory being operable to provide a buffer for storage of data from the distributed storage unit for a read request from a client, a trigger control, the trigger control including a programmable trigger condition, and a port for connection of the RNIC to the client; and a system memory, the system memory to include a driver for the distributed storage unit. In some embodiments, the RNIC is operable to support a speculative read of data in response to the read request snoop of a write of data to the onboard memory and, upon detecting the trigger condition, to provide the data in the buffer to the client.

In some embodiments, the distributed storage unit is one of a block based storage system or a distributed object storage system.

In some embodiments, the distributed storage unit is an NVMe (Non-Volatile Memory Express) over Fabric system.

In some embodiments, the trigger condition is programmable by software of the server system.

In some embodiments, the RNIC is to provide the data in the buffer to the client prior to completion of the read request by the server.

In some embodiments, the distributed storage unit is an NVMe (Non-Volatile Memory Express) storage unit, and wherein the data is provided to the client prior to the CPU obtaining a read request completion from an NVMe completion queue.

In some embodiments, providing the data in the buffer to the client includes transferring the data from the RNIC to an RNIC for the client.

In some embodiments, a non-transitory computer-readable storage medium having stored thereon data representing sequences of instructions that, when executed by a processor, cause the processor to perform operations comprising: receiving, at a server including a distributed storage system, a read request from a client; upon receiving the read request, allocating onboard memory of a remote direct memory access (RDMA) network interface card (RNIC) for the read request; setting a trigger condition to enable a speculative RDMA write to a client read buffer; directing the read request to the distributed storage system; setting a buffer in the allocated memory on the RNIC; performing the requested read by the distributed storage system and providing a direct memory access (DMA) write of obtained read data to the RNIC buffer; snooping, by the RNIC, the DMA write to the RNIC buffer, upon meeting the trigger condition for the speculative read, triggering a write of the data in RNIC buffer to the client; and completing the read request including writing a Completion Queue Entry in in a Completion Queue in system memory.

In some embodiments, the write of the data to the user is performed before completion of the read request.

In some embodiments, the request from the client includes an identification of a client buffer to directly receive requested read data.

In some embodiments, the distributed storage system is one of a block based storage system or a distributed object storage system.

In some embodiments, the distributed storage system is an NVMe (Non-Volatile Memory Express) over Fabric system.

In some embodiments, setting the trigger condition to enable a speculative RDMA write to a client read buffer includes software of the server setting the trigger conditions.

In some embodiments, the RNIC is to provide the data in the buffer to the client prior to completion of the read request by the server.

In some embodiments, the distributed storage system is an NVMe (Non-Volatile Memory Express) storage system, and wherein providing the data to the client includes providing the data prior to a central processing unit (CPU) obtaining a read request completion from an NVMe completion queue.

In some embodiments, providing the data to the client includes transferring the data from the RNIC to an RNIC for the client.

In some embodiments, an apparatus includes a means for receiving, at a server including a distributed storage system, a read request from a client; a means for allocating onboard memory of a remote direct memory access (RDMA) network interface card (RNIC) for the read request upon receiving the read request; a means for setting a trigger condition to enable a speculative RDMA write to a client read buffer, a means for directing the read request to the distributed storage system; a means for setting a buffer in the allocated memory on the RNIC; a means for performing the requested read by the distributed storage system and providing a direct memory access (DMA) write of obtained read data to the RNIC buffer; a means for snooping, by the RNIC, the DMA write to the RNIC buffer; a means for triggering a write of the data in RNIC buffer to the client upon meeting the trigger condition for the speculative read; and a means for completing the read request including writing a Completion Queue Entry in in a Completion Queue in system memory.

In some embodiments, the write of the data to the user is performed before completion of the read request.

In some embodiments, the request from the client includes an identification of a client buffer to directly receive requested read data.

In some embodiments, the distributed storage system is one of a block based storage system or a distributed object storage system.

In some embodiments, the distributed storage system is an NVMe (Non-Volatile Memory Express) over Fabric storage system.

In some embodiments, the means for setting the trigger condition to enable a speculative RDMA write to a client read buffer includes software of the server setting the trigger conditions.

In some embodiments, the RNIC is to provide the data in the buffer to the client prior to completion of the read request by the server.

In some embodiments, the distributed storage system is an NVMe (Non-Volatile Memory Express) storage system, and wherein the means for providing the data to the client includes a means for providing the data prior to a central processing unit (CPU) obtaining a read request completion from an NVMe completion queue.

In some embodiments, the means for providing the data to the client includes a means for transferring the data from the RNIC to an RNIC for the client.

1. An apparatus comprising:
a remote direct memory access (RDMA) network interface card (RNIC) for a server, wherein the RNIC includes:
an onboard memory, the onboard memory being operable to provide a buffer for storage of data from a distributed storage system for a read request from a client,
a trigger control, the trigger control including a programmable trigger condition, and
a port for connection of the RNIC to the client;
wherein the RNIC is operable to support a speculative read of data in response to a read request snoop of a write of data to the onboard memory and, upon detecting the trigger condition, to provide the data in the buffer to the client.

2. The apparatus of claim 1, wherein the trigger condition is programmable by the server.

3. The apparatus of claim 1, wherein the RNIC is to provide the data in the buffer to the client prior to completion of the read request by the server.

4. The apparatus of claim 3, wherein the distributed storage system is an NVMe (Non-Volatile Memory Express) system, and wherein the data is provided to the client prior to a central processing unit (CPU) of the server obtaining a read request completion from an NVMe completion queue.

5. The apparatus of claim 1, wherein providing the data in the buffer to the client includes transferring the data from the RNIC to an RNIC for the client.

6. A server system comprising:
a central processing unit (CPU);
a distributed storage unit;
a remote direct memory access (RDMA) network interface card (RNIC) including:
an onboard memory, the onboard memory being operable to provide a buffer for storage of data from the distributed storage unit for a read request from a client,
a trigger control, the trigger control including a programmable trigger condition, and
a port for connection of the RNIC to the client; and
a system memory, the system memory to include a driver for the distributed storage unit;
wherein the RNIC is operable to support a speculative read of data in response to a read request snoop of a write of data to the onboard memory and, upon detecting the trigger condition, to provide the data in the buffer to the client.

7. The server system of claim 6, wherein the distributed storage unit is one of a block based storage system or a distributed object storage system.

8. The server system of claim 7, wherein the distributed storage unit is an NVMe (Non-Volatile Memory Express) over Fabric system.

9. The server system of claim 6, wherein the trigger condition is programmable by software of the server system.

10. The server system of claim 6, wherein the RNIC is to provide the data in the buffer to the client prior to completion of the read request by the server.

11. The server system of claim 10, wherein the distributed storage unit is an NVMe (Non-Volatile Memory Express) storage unit, and wherein the data is provided to the client prior to the CPU obtaining a read request completion from an NVMe completion queue.

12. The server system of claim 6, wherein providing the data in the buffer to the client includes transferring the data from the RNIC to an RNIC for the client.

13. A non-transitory computer-readable storage medium having stored thereon data representing sequences of instructions that, when executed by a processor, cause the processor to perform operations comprising:
receiving, at a server including a distributed storage system, a read request from a client;
upon receiving the read request, allocating onboard memory of a remote direct memory access (RDMA) network interface card (RNIC) for the read request;
setting a trigger condition to enable a speculative RDMA write to a client read buffer;
directing the read request to the distributed storage system;
setting a buffer in the allocated memory on the RNIC;
performing the requested read by the distributed storage system and providing a direct memory access (DMA) write of obtained read data to the RNIC buffer;
snooping, by the RNIC, the DMA write to the RNIC buffer;
upon meeting the trigger condition for the speculative read, triggering a write of the data in RNIC buffer to the client; and
completing the read request including writing a Completion Queue Entry in in a Completion Queue in system memory.

14. The medium of claim 13, wherein the write of the data to the user is performed before completion of the read request.

15. The medium of claim 13, wherein the request from the client includes an identification of a client buffer to directly receive requested read data.

16. The medium of claim 13, wherein the distributed storage system is one of a block based storage system or a distributed object storage system.

17. The medium of claim 16, wherein the distributed storage system is an NVMe (Non-Volatile Memory Express) over Fabric system.

18. The medium of claim 13, wherein setting the trigger condition to enable a speculative RDMA write to a client read buffer includes software of the server setting the trigger conditions.

19. The medium of claim 13, wherein the RNIC is to provide the data in the buffer to the client prior to completion of the read request by the server.

20. The medium of claim 13, wherein the distributed storage system is an NVMe (Non-Volatile Memory Express) system, and wherein providing the data to the client includes providing the data prior to a central processing unit (CPU) obtaining a read request completion from an NVMe completion queue.

21. The medium of claim 13, wherein providing the data to the client includes transferring the data from the RNIC to an RNIC for the client.
